(19) United States
(12) Patent Application Publication
(10) Pub. No.: US 2012/0228196 A1
(43) Pub. Date: Sep. 13, 2012

(54) Methods of Preparing Bituminous Material for Bitumen Extraction

(75) Inventors: Julian Kift, Reno, NV (US); Mahendra Joshi, Katy, TX (US)

(73) Assignee: MARATHON OIL CANADA CORPORATION, Calgary (CA)

(21) Appl. No.: 13/418,044

(22) Filed: Mar. 12, 2012

Related U.S. Application Data
(60) Provisional application No. 61/451,963, filed on Mar. 11, 2011.

(51) Int. Cl. B02C 4/02

(52) U.S. Cl. 208/426

(57) ABSTRACT

Methods of preparing bituminous material for extraction processing are described. The methods can include mixing bituminous material with hydrocarbon solvent before and/or during a step of crushing the bituminous material to reduce the size of clumps contained in the bituminous material. The steps of adding hydrocarbon solvent and crushing the bituminous material can be carried out multiple times.

This application claims priority to U.S. Provisional Application No. 61/451,963, filed Mar. 11, 2011, the entirety of which is hereby incorporated by reference.

### BACKGROUND

In many non-aqueous or solvent-based bitumen extraction processes performed on bituminous material (such as oil sands), numerous pre-extraction preparation steps are carried out in order to improve bitumen recovery rates. Two exemplary preparation steps carried out in some solvent-based bitumen extraction methods are the dry crushing of the bituminous material and the mixing of the crushed bituminous material with solvent to begin disaggregation. Dry crushing of bituminous material is generally performed to reduce the size of clumps of bituminous material and put the bituminous material in better condition for further processing steps. Disaggregation is generally performed to soften the bitumen in the bituminous material and reduce the viscosity of the bituminous material by dissolving a portion of the bitumen in the solvent (which can then be removed as a dissolved bitumen solution, i.e., “disbit”).

Various undesirable issues can arise with both of these preparation steps. Perhaps the biggest issue with the dry crushing preparation step is the increased wear and tear experienced by crushing apparatus (e.g., roller surfaces or teeth) typically used to crush dry lumps of bituminous material. This increased wear and tear can result in increased maintenance and process downtime, which lowers the overall profitability of the bitumen extraction process. To counteract such wear and tear, more durable material can be used for the crusher apparatus, but this material tends to be more expensive and drives up the capex of the process.

For the disaggregation pretreatment step, one of the more prominent issues can be the inadequate mixing of solvent and bituminous material. Typical apparatus used for disaggregation, such as mixers and thickeners, are not always capable of performing adequate mixing, which can thereby require additional residence time in disaggregation apparatus, require additional stages of disaggregation, and reduce subsequent bitumen separation efficiency.

### SUMMARY

The foregoing and other features, utilities, and advantages of the disclosed method will be apparent from the following more particular description of preferred embodiments of the disclosed method as illustrated in the accompanying drawings.

In some embodiments, a method includes i) providing bituminous material, wherein the bituminous material includes clumps of the bituminous material; ii) adding a hydrocarbon solvent to the bituminous material and forming solvent-wet bituminous material; iii) crushing the solvent-wet bituminous material and producing crushed solvent-wet bituminous material; iv) adding additional hydrocarbon solvent to the crushed solvent-wet bituminous material; and v) crushing the crushed solvent-wet bituminous material and forming a twice crushed solvent-wet bituminous material.

In some embodiments, a method includes i) introducing a bituminous material into a crushing apparatus having a first stage of crushing mechanisms and a second stage of crushing mechanisms located downstream of the first stage of crushers; ii) spraying the bituminous material with a hydrocarbon solvent prior to crushing the bituminous material with the first stage of crushing mechanisms and forming solvent-wet bituminous material; iii) crushing the solvent-wet bituminous material with the first stage of crushing mechanisms and forming crushed solvent-wet bituminous material; iv) spraying the crushed solvent-wet bituminous material with additional hydrocarbon solvent prior to crushing the crushed solvent-wet bituminous material with the second stage of crushing mechanisms; and v) crushing the crushed solvent-wet bituminous material with the second stage of crushing mechansisms and forming twice crushed solvent-wet bituminous material.

In some embodiments, a method includes adding a hydrocarbon solvent to clumps of bituminous material and forming solvent-wet clumps of bituminous material and reducing the size of the solvent-wet clumps of bituminous material.

Each of the above described embodiments can provide one or more advantages over previously known methods, including but not limited to, providing a wet crushing process that reduces the wear and tear on crushing apparatus and correspondingly reduces maintenance and downtime, and providing improved disaggregation by using the crushing apparatus as means for more intimate mixing between the solvent and bituminous material.

### BRIEF DESCRIPTION OF THE DRAWING

The preferred and other embodiments are disclosed in association with the accompanying drawing in which:

FIG. 1 is a flow chart detailing embodiments of methods described herein;

FIG. 2 is a schematic diagram of a crushing apparatus suitable for use in carrying out embodiments of the method described herein; and

FIG. 3 is a schematic diagram of a crushing apparatus suitable for use in carrying out embodiments of the method described herein.

### DETAILED DESCRIPTION

The methods described herein generally entail mixing a hydrocarbon solvent with bituminous material before or while the bituminous material is crushed by a crushing mechansism to reduce the size of clumps in the bituminous material. In this manner, the methods can reduce the wear and tear on crushing apparatus by providing a wet as opposed to dry material for crushing and improve disaggregation by using the crusher apparatus to promote intimate mixing between the hydrocarbon solvent and the bituminous material.

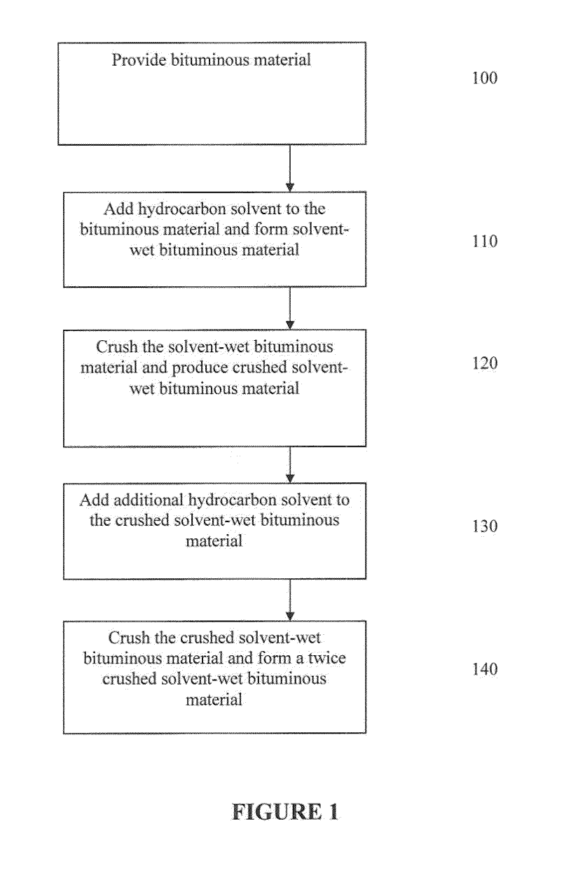

With reference to FIG. 1, some embodiments of the method generally include a step 100 of providing bituminous material, a step 110 of adding a hydrocarbon solvent to the bituminous material and forming solvent-wet bituminous material, a step 120 of crushing the solvent-wet bituminous material and producing crushed solvent-wet bituminous material, a step 130 of adding additional hydrocarbon solvent to the crushed solvent-wet bituminous material, and a step 140 of crushing the crushed solvent-wet bituminous material and forming a twice crushed solvent-wet bituminous material.

Regarding the step 100 of providing the bituminous material, generally speaking any material having a bitumen content can be provided. In some embodiments, the bituminous material includes a bitumen content in the range of from less than 3 wt % bitumen to greater than 20 wt % bitumen. Exemplary bituminous material suitable for use in embodiments disclosed herein includes, but is not limited to, tar sands, oil sands, black shales, coal formations, and hydrocarbon sources contained in sandstones and carbonates. The bituminous material can be obtained by any known methods for obtaining bituminous material, such as by surface mining, underground mining, or any in situ extraction methods. In some embodiments, the bituminous material will include clumps of bituminous material of varying sizes. Clumps included in the bituminous material provided in step 100 can range from having a diameter of 2 inches to larger than 3 feet. Generally speaking, the amount of bituminous material provided in step 100 will depend on the capacity of the crushing apparatus used and the amount of hydrocarbon solvent available.

Regarding the step 110 of adding hydrocarbon solvent to the bituminous material and forming solvent-wet bituminous material, the hydrocarbon solvent used can generally include any hydrocarbon solvent or mixture of hydrocarbon solvents capable of dissolving bitumen. In some embodiments, the hydrocarbon solvent is a hydrocarbon solvent that does not result in asphaltene precipitation. In some embodiments, the hydrocarbon solvent may be light enough to precipitate a controlled amount of asphaltenes or, alternatively, may be used at a sufficiently low S:B (solvent to bitumen) ratio that asphaltenes remain in solution until a later processing stage where additional solvent is added to precipitate them in a controlled environment. The advantage of such a controlled precipitation process is the improved product quality, as the asphaltenes have been shown to seed on suspended line clay solids which facilitates their removal with the asphaltene solids product. The hydrocarbon solvent or mixture of hydrocarbon solvents can be economical and relatively easy to handle and store. The hydrocarbon solvent or mixture of hydrocarbon solvents may also be generally compatible with refinery operations.

In some embodiments, the first solvent may be an aromatic hydrocarbon solvent. In some embodiments, the aromatic hydrocarbon solvent is an aromatic hydrocarbon compound having a boiling point temperature less than about 400° C. at atmospheric pressure. In some embodiments, the aromatic hydrocarbon solvent used in the spraying step may be an aromatic having a boiling point temperature in the range of from about 75° C. to about 350° C. at atmospheric pressure, and more specifically, in the range of from about 100° C. to about 250° C. at atmospheric pressure.

It should be appreciated that the aromatic hydrocarbon solvent need not be 100% aromatic compounds. Instead, the aromatic hydrocarbon solvent may include a mixture of aromatic and non-aromatic compounds. For example, the solvent used in the spraying step can include greater than zero to about 100 wt % aromatic compounds, such as approximately 10 wt % to 100 wt % aromatic compounds, or approximately 20 wt % to 100 wt % aromatic compounds.

Any of a number of suitable aromatic compounds may be used as the aromatic hydrocarbon solvent. Examples of aromatic compounds that can be used in the spraying step include benzene, toluene, xylene, aromatic alcohols and combinations and derivatives thereof. The aromatic hydrocarbon solvent can also include compositions, such as kerosene, diesel (including biodiesel), light gas oil, light distillate (distillate having boiling point temperature in the range of from 140° C. to 260° C.), commercial aromatic solvents such as Aromatic 100, Aromatic 150, and Aromatic 200 (produced by ExxonMobil), and/or naphtha.

In some embodiments, the hydrocarbon solvent sprayed over the bituminous material is a paraffinic hydrocarbon solvent, such as ethane, butane, pentane, hexane and heptane. It should be appreciated that the paraffinic hydrocarbon solvent need not be 100% paraffinic compounds. Instead, the paraffinic hydrocarbon solvent may include a mixture of paraffinic and non-paraffinic compounds. For example, the solvent used in the spraying step can include greater than zero to about 100 wt % paraffinic compounds, such as approximately 10 wt % to 100 wt % paraffinic compounds, or approximately 20 wt % to 100 wt% paraffinic compounds.

In some embodiments, the hydrocarbon solvent is a solution of bitumen dissolved in a hydrocarbon solvent (such as the aromatic or paraffinic hydrocarbon solvents described above). This solution can be referred to as “disbit” and can be obtained from processing steps occurring downstream of the methods described herein. In some embodiments, the disbit is disbit separated from the bituminous material subjected to the hydrocarbon solvent addition and crushing steps described herein. As discussed in greater detail below, after having been sprayed with solvent and crushed, the crushed solvent-wet bituminous material can be filtered or screened to separate the disbit solution from the solid material. The disbit collected from such a separation step can be recycled back into the crushing apparatus for use in spraying additional bituminous material fed into the crushing apparatus.

In some embodiments, the hydrocarbon solvent is pre-heated prior to being added to the bituminous material. The hydrocarbon solvent can be heated to any suitable temperature, such as an elevated temperature that is still below the boiling point of the hydrocarbon solvent. In some embodiments, the hydrocarbon solvent is heated to within a range of from 50° F. to 100° F. Any suitable manner of heating the hydrocarbon solvent can be used, including reusing heat generated from other processing equipment in the vicinity of the method described herein.

Adding the hydrocarbon solvent to the bituminous material can be carried out in any suitable manner that wets the bituminous material with hydrocarbon solvent and begins the process of dissolving bitumen in the hydrocarbon solvent. In some embodiments, the hydrocarbon solvent is sprayed over the bituminous material. For example, a crushing apparatus can be configured with one or more spray nozzles for spraying hydrocarbon solvent over the bituminous material before and/or as the bituminous material passes through the crushing mechanism (e.g., a crushing roller). In other embodiments, the hydrocarbon solvent and the bituminous material can be mixed together to form solvent-wet bituminous material prior to being introduced into a crushing apparatus. In other words, a mixing vessel separate from the crushing apparatus can be provided that prepares the solvent-wet bituminous material prior to introducing the bituminous material into the crushing apparatus. Any suitable mixing vessel, including a mixing vessel having mixing, blades, can be used. Adding hydrocarbon solvent to the bituminous material can also be carried out on the conveyors, buckets, or chutes used to transport the bituminous material to the crushing apparatus.

In some embodiments, the amount of hydrocarbon solvent added to the bituminous material is based on a hydrocarbon solvent to bitumen content of bituminous material ratio, or S:B ratio. The S:B ratio is on a volume basis, and compares the volume of bitumen in the bituminous material to the volume of hydrocarbon solvent added to the bituminous material. In some embodiments, the S:B ratio is from 0.5:1 to 3:1. Because the S:B ratio is based on the volume of bitumen in the bituminous material, it can be seen that more hydrocarbon solvent will generally be needed for bituminous material having a higher bitumen content then is need for lower bitumen content bituminous material. In some embodiments, the range of S:B ratio noted above can accomplish the controlled asphaltene precipitation described in greater detail above.

In step 120, the solvent-wet bituminous material is subsequently crushed in order to reduce the size of clumps of bituminous material and assist with further mixing between the hydrocarbon solvent and the bituminous material. Any manner of crushing the solvent-wet bituminous material can be used, including the use of crushing apparatus known to those of ordinary skill in the art. Exemplary crushing mechanisms include, but are not limited to, crushing rollers or sizers.

In some embodiments, the solvent-wet bituminous material is crushed by passing the solvent-wet bituminous material through crushing rollers. The crushing rollers can be individually driven by electrical motors, gear motors, or with coupling and gears counter rotating via V-belts. Even distribution of the solvent-wet bituminous material across the entire length of the crushing rollers or other crushing mechanisms, the use of a favorable angle of entry, and in the case of crusher rollers, the adjusting the speed and diameter of the crusher rollers, can help to ensure efficient crushing of the solvent-wet bituminous material and reduced wear and tear on the crushing mechanism.

Crushing rollers used to crush the solvent-wet bituminous material can also be internally heated to help improve disaggregation. Any suitable manner of internally heating the crushing rollers can used, such as through the use of steam, hot water, or electricity. The crusher rollers can be heated to any suitable temperature for improving disaggregation. In some embodiments, the crusher rollers are heated to a temperature below the boiling point temperature of the hydrocarbon solvent, such as from 50° F. to 100° F.

In some embodiments, the crusher rollers are provided with perforations or holes that deliver hydrocarbon solvent to the surface of the crusher rollers. Providing hydrocarbon solvent in this manner can create a wet film on the surface of the crusher rollers that further reduced mechanical wear and tear on the surface of the crusher rollers. The hydrocarbon solvent delivered through these holes can be heated and can be delivered to the surface of the crusher rollers continuously or intermittently.

In some embodiments, conveyors can be used to deliver bituminous material into the crushing apparatus. In instances where the bituminous material is wetted with hydrocarbon solvent prior to being introduced into the crushing apparatus, the conveyors can be used to deliver solvent-wet bituminous material into the crushing apparatus. In instances where the mechanism for adding hydrocarbon solvent to the bituminous material is incorporated into the crushing apparatus (e.g. spray nozzles located within the crushing apparatus and upstream of the crushing mechanism), the conveyors can be used to deliver dry bituminous material into the crushing apparatus.

In some embodiments, the crushing of the solvent-wet bituminous material aims to eliminate most or all of the clumps of bituminous material above a certain size. For example, the crushing step can be designed to reduce the size of the clumps of the bituminous material to below 2 inches, although any other size restraint can be imposed (based on, e.g., downstream process requirements).

In some embodiments, the step 110 of adding hydrocarbon solvent to the bituminous material and the step 120 of crushing the solvent-wet bituminous material are repeated as steps 130 and 140. In step 130, additional hydrocarbon solvent can be added to the crushed solvent-wet bituminous material produced by the first hydrocarbon solvent addition step and the first crushing step, followed by a step 140 of subjecting the crushed solvent-wet bituminous material to a second crushing step.

When additional hydrocarbon solvent is added to the crushed solvent-wet bituminous material in step 130, the addition of the additional hydrocarbon solvent can be carried out in a similar or identical manner to the first step of adding hydrocarbon solvent to the bituminous material. For example, the same hydrocarbon solvents (e.g., aromatic, paraffinic, or disbit) can be used, the hydrocarbon solvent can be sprayed over the crushed solvent-wet bituminous material prior to or during the second crushing step, and the additional hydrocarbon solvent can be added to the crushed solvent-wet bituminous material within the same S:B ratio discussed above. In some embodiments, the S:B ratio for adding the additional hydrocarbon solvent will still be within the range of 0.5:1 to 3:1, but will be less than the S:B ratio used in the first hydrocarbon solvent addition step to produce a final solvent-wet bituminous material with a S:B ratio in the range of 0.5:1 to 3:1.

The second crushing step 140 can be similar or identical to the first crushing step 120 described in greater detail above, including the use of crushing rollers or sizers. In some embodiments, a second set of crushing mechanisms will be provided downstream of the first set of crushing mechanism so that the crushed solvent-wet bituminous material can be subjected to further crushing. In some embodiments, the second set of crushing mechanisms will be designed to reduce the size of the clumps of the bituminous material to a size lower than the first set of crushing mechanisms. For example, if the first set of crushing mechanisms produce a solvent-wet bituminous material having clumps no larger than 12 inches, the second set of crushing mechanisms can he designed to produce a twice crushed solvent-wet bituminous material having clumps no larger than 2 to 4 inches. In some embodiments (and depending on the type of crushing mechanism used (e.g., roll crushers, sizer, etc.)), the two sets of crushing mechanisms may be directly stacked over each other or act as a continuous unit.

While only two solvent addition and crushing steps are described above, the solvent addition and crushing steps can be repeated any suitable number of times to produce a crushed bituminous material product suitable for further extraction processing.

In some embodiments, the method can further include steps for separating a dissolved bitumen solution (“disbit”) from the twice crushed solvent-wet bituminous material and separating the disbit into a bitumen stream and a solvent stream. Such processing can be useful to remove the already sufficiently separated bitumen (in the form of disbit) from the twice crushed bituminous material requiring further extraction processing. Additionally, the separation of the disbit into a bitumen stream and a solvent stream allows for the reuse of the solvent in the hydrocarbon solvent addition steps described above. The separated disbit can also be recycled back to the crushing apparatus for being added to bituminous material before or during a crushing step.

Disbit can be removed from the twice crushed bituminous material in any suitable manner known to those of ordinary skill in the art, including the use of mesh screens that allow disbit to pass through but prevent the crushed bituminous material requiring further bitumen extraction from passing through. Accordingly, in some embodiments, the crushing apparatus will include a screen located downstream of the final crushing stage for separating the disbit from the crushed bituminous material. The crushed bituminous material can then be diverted to further extraction processing, while the disbit can be transported to an apparatus capable of separating the solvent from the bitumen.

Any separating apparatus capable of separating the disbit into a solvent stream and a bitumen stream can be used. In some embodiments, the separation apparatus can be a distillation tower that evaporates the solvent in order to remove it from the bitumen content of the disbit. The evaporated solvent can then be re-condensed and recycled back to be used in the steps of adding hydrocarbon solvent to the bituminous material. In some embodiments, a make-up solvent stream may used in conjunction with the recovered and recycled solvent to ensure enough solvent is available for the hydrocarbon solvent addition stages.

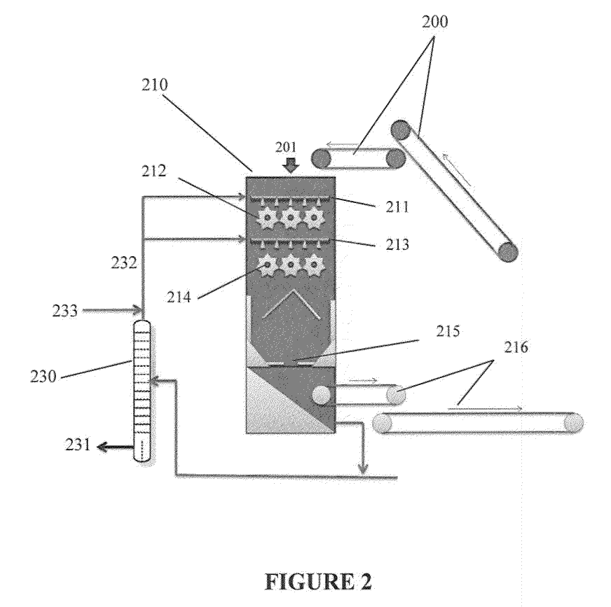

FIG. 2 illustrates an exemplary apparatus capable of being used to carry out the methods described herein. The apparatus generally includes various conveyor belts and apron feeders 200 for introducing bituminous material 201 into the crushing apparatus 210. The conveyor belts 200 deliver the bituminous material 201 to the top of the crushing apparatus 210 so that gravity can be used a means for moving the bituminous material 201 down through the crushing apparatus 210. While not shown in FIG. 2, the crushing apparatus containing solvent vapors can be sealed from the external environment and purged with an inert gas to eliminate an explosive atmosphere. This can be achieved by any manner of commercially available apparatus (e.g., a rotary valve feeding to the crusher or through a storage bin over the crusher acting as a seal when full of bituminous material).

As shown FIG. 2, the crushing apparatus 210 includes a first spray bar 211 for spraying bituminous material 201 with hydrocarbon solvent prior to being crushed by the first stage of crushing rollers 212, a first stage of crushing rollers 212 located downstream of the first spray bar 211, a second spray bar 213 located between the first stage of crushing rollers 212 and the second stage of crushing rollers 214, and second stage of crushing rollers 214. This configuration allows for bituminous material 201 introduced at the top of the crushing apparatus 210 to be sprayed with a suitable amount of hydrocarbon solvent to produce a solvent-wet bituminous material. The solvent-wet bituminous material then passes through the first stage of crushing rollers 212 to reduce the size of any bituminous material clumps to below a predetermined size (e.g., less than 12 inches). The second spray bar 213 adds additional hydrocarbon solvent to the crushed solvent-wet bituminous material passing through the first stage of crushing rollers 212. After having been sprayed with additional hydrocarbon solvent, the crushed solvent-wet bituminous material is passed through a second stage of crushing rollers 214 to further reduce the size of any clumps in the bituminous material. As noted above, the second stage of crushing rollers 214 can be designed to reduce the size of the bituminous material clumps to a size smaller than was accomplished by the first stage of crushing rollers 212.

Also shown in FIG. 2 is the mechanism put in place to separate a disbit stream from the twice crushed solvent-wet bituminous material passing through the second stage of crushing rollers 214. Generally speaking, this can include a screen 215 that allows disbit to pass through while collecting the crushed bituminous material still requiring further bitumen extraction. The crushed bituminous material can be carried out of the crushing apparatus on a conveyor 216 that sends the crushed bituminous material to an extraction plant. The separated disbit that has passed through the screen can be treated for further solids removal if required (e.g. via a thickener, clarifier, or centrifuge) and transported (such as through a pipeline) to a distillation tower 230, where the disbit is separated into a bitumen stream 231 and a recovered solvent stream 232. The bitumen stream 231 is a product of the overall process that can be sent to an upgrading facility where the bitumen is broken down into lighter, more commercially useful hydrocarbon material. The recovered solvent 232 can be diverted back to the crushing apparatus 210, where it is added to the bituminous material 201 via either the first spray bar 211 or the second spray bar 213. A make-up solvent stream 233 can be added to the recovered and recycled solvent stream where necessary.

While the crushing apparatus shown in FIG. 2 illustrates only two spray bars and two stages of crushing rollers, any number of spray bars and crushing rollers can be provided to ensure a sufficient reduction in the size of the bituminous material and effective disaggregation (including the collection of the disbit stream).

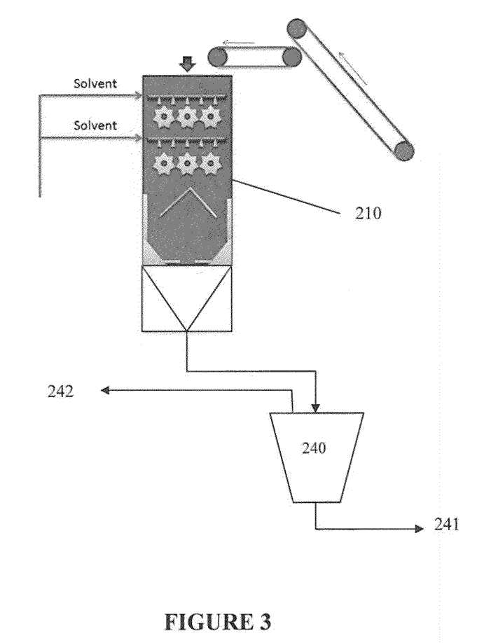

With reference to FIG. 3, an alternative crushing apparatus configuration is shown, wherein the twice-crushed solvent-wet bituminous material has sufficient liquid content to be pumpable and can be transported using pumps and the like. As shown in FIG. 32, the twice crushed solvent-wet bituminous material is transported to a thickener or clarifier 240 for purposes of separating the twice crushed solvent-wet bituminous material into a solids stream 241 and a liquid stream 242. The liquid stream 242 can generally include disbit. The solids stream 241 can generally include inorganic material such as sand and clay, and will have a depleted amount of solvent and bitumen.

This solids stream 241 produced by the thickener or clarifier 240 shown in FIG. 3 can be sent to further processing apparatus, such as processing apparatus that will recover additional solvent and bitumen from the solids stream 241. Any suitable recovery can be used, including the double solvent extraction methods described in U.S. Pat. Nos. 7,909,989, 7,985,333, and 8,101,067 and U.S. patent application Ser. Nos. 12/512,758, 12,560,964, 12/648,164, 12/692,127, and 12/956,701.

The liquid stream 242 can be sent to separation apparatus to separate the liquid stream into a bitumen stream and a solvent stream. The separation unit can include the distillation tower shown in FIG. 2. In such instances, the recovered solvent can be recycled for use in the hydrocarbon solvent addition steps described herein. Alternatively, the liquid stream 242 can be directly recycled back for use in the hydrocarbon solvent addition steps described herein, such as when the liquid stream 242 is disbit having a suitable bitumen content.

We claim:

1. A method comprising:
i) providing bituminous material, wherein the bituminous material includes clumps of the bituminous material;
ii) adding a hydrocarbon solvent to the bituminous material and forming solvent-wet bituminous material;
iii) crushing the solvent-wet bituminous material and producing crushed solvent-wet bituminous material;
iv) adding additional hydrocarbon solvent to the crushed solvent-wet bituminous material; and
v) crushing the crushed solvent-wet bituminous material and forming a twice crushed solvent-wet bituminous material.

2. The method as recited in claim 1, wherein the bituminous material is oil sands including clumps of oil sands.

3. The method as recited in claim 1, wherein the hydrocarbon solvent is aromatic hydrocarbon solvent.

4. The method as recited in claim 1, wherein the hydrocarbon solvent is paraffinic hydrocarbon solvent.

5. The method as recited in claim 1, wherein the bituminous material is added to the hydrocarbon solvent at a solvent to bituminous material bitumen content ratio of from 1 to 3 on a volume basis.

6. The method as recited in claim 1, further comprising:
vi) separating a dissolved bitumen solution from the twice crushed solvent-wet bituminous material;
vii) separating the dissolved bitumen solution into a bitumen stream and a recovered hydrocarbon solvent stream; and
viii) using the recovered hydrocarbon stream in step ii) or iv).

7. The method as recited in claim 1, wherein the crushing in step iii) is carried out with a first stage of crusher rollers, the crushing in step v) is carried out with a second stage of crusher rollers, and the second stage of crusher rollers are located downstream of the first stage of crusher rollers.

8. The method as recited in claim 7, wherein adding hydrocarbon solvent to the bituminous material in step ii) is carried out with a first solvent sprayer, adding additional hydrocarbon solvent to the crushed solvent-wet bituminous material in step iv) is carried out with a second solvent sprayer, and the first solvent sprayer is located upstream of the first stage of crusher rollers and the second solvent sprayer is located downstream of the first stage of crusher rollers and upstream of the second stage of crusher rollers.

9. A method comprising:
i) introducing a bituminous material into a crushing apparatus having a first stage of crushers and a second stage of crushers located downstream of the first stage of crushers;
ii) spraying the bituminous material with a hydrocarbon solvent prior to the bituminous crushing the bituminous material with the first stage of crushing mechanisms and forming solvent-wet bituminous material;
iii) crushing the solvent-wet bituminous material with the first stage of crushing mechanisms and forming crushed solvent-wet bituminous material;
iv) spraying the crushed solvent-wet bituminous material with additional hydrocarbon solvent prior to crushing the crushed solvent-wet bituminous material with the second stage of crushing mechanisms; and
v) crushing the crushed solvent-wet bituminous material with the second stage of crushing mechanisms and forming twice crushed solvent-wet bituminous material.

10. The method as recited in claim 9, wherein the bituminous material is oil sands including clumps of oil sands.

11. The method as recited in claim 9, wherein the hydrocarbon solvent is aromatic hydrocarbon solvent.

12. The method as recited in claim 9, wherein the hydrocarbon solvent is paraffinic hydrocarbon solvent.

13. The method as recited in claim 9, wherein the bituminous material is sprayed with the hydrocarbon solvent at a solvent to bituminous material bitumen content ratio of from 1 to 3 on a volume basis.

14. The method as recited in claim 9, further comprising:
vi) separating a dissolved bitumen solution from the twice crushed solvent-wet bituminous material;
vii) separating the dissolved bitumen solution into a bitumen stream and a recovered hydrocarbon solvent stream; and
viii) using the recovered hydrocarbon stream in step ii) or iv).

15. A method comprising:
adding a hydrocarbon solvent to clumps of bituminous material and forming solvent-wet clumps of bituminous material; and
reducing the size of the solvent-wet clumps of bituminous material.

16. The method as recited in claim 15, wherein the bituminous material is oil sands including clumps of oil sands.

17. The method as recited in claim 15, wherein the hydrocarbon solvent is an aromatic hydrocarbon solvent.

18. The method as recited in claim 15, wherein the hydrocarbon solvent is a paraffinic hydrocarbon solvent.

19. The method as recited in claim 15, wherein the bituminous material is sprayed with the hydrocarbon solvent at a solvent to bituminous material bitumen content ratio of from 1 to 3 on a volume basis.
